(19) United States
(12) Patent Application Publication
(10) Pub. No.: US 2002/0072401 A1
(43) Pub. Date: Jun. 13, 2002

(54) Racing game machine and method of establishing special race therein

(75) Inventors: Hiroshi Tomaru, Tokyo (JP); Kazuhiro Yoshida, Tokyo (JP); Yosuke Sasaki, Tokyo (JP)

Correspondence Address: SUGHRUE, MION, ZINN,, MACPEAK & SEAS, PLLC, Pennsylvania Avenue, N.W., Washington, DC, 20037, US

(73) Assignee: KONAMI CORPORATION

(21) Appl. No.: 10/002,156

(22) Filed: Dec. 5, 2001

(30) Foreign Application Priority Data
Dec. 8, 2000 (JP) P. 2000-375143

(51) Int. Cl. G06F 17/00

(52) U.S. Cl. 463/6

(57) ABSTRACT

In a racing game in which a plurality of racing members, each having a member name, participate in a plurality of races taken place therein, a player name which is registered by a game player is assigned to an associated racing member as a part of the member name thereof. When a racing member to which one player name is assigned has a better race record than another racing members have. A special race having a race name is established as one of the plural races, and the one player name is assigned to the special race as a part of the race name thereof.

### BACKGROUND OF THE INVENTION

The present invention relates to a racing game machine, which performs a horseracing game or the like, and to a method of establishing a special race therein.

A token game machine embodying a racing game, such as a horseracing game, as a token game, has been known. For instance, in a token game machine described in Japanese Patent Publication No. 2000-288246A, a player can purchase a betting ticket, by betting game tokens with a predication about the sequence in which horses finish. Further, a player purchases a racehorse with game tokens, thus becoming an owner. By causing the horse to participate in a race, the owner can acquire game tokens as winnings when the horse has won the race. The winning average of a horse can be increased by selecting a stable, the type of training, and a jockey.

In the above-described token game machine, a player's interest in a game is increased as a result of the player participating in a race held in a game or in training of a racehorse. Further, a game participant's ability to train a racehorse is evaluated. Thus, a game value is further improved. However, no matter how strong a racehorse a gamer has trained, simple increase in the number of acquired game tokens fails to satisfy the gamer's self-esteem.

### SUMMARY OF THE INVENTION

It is therefore an object of the present invention to provide a racing game machine and a method of establishing a special race therein, which not only increases a gamer's interest in a game but also satisfies the self-esteem of the gamer.

In order to achieve the above object, according to the present invention, in a racing game in which a plurality of racing members, each having a member name, participate in a plurality of races taken place therein, a player name which is registered by a game player is assigned to an associated racing member as a part of the member name thereof. When a racing member to which one player name is assigned has a race record better than race records of another racing members, a special race having a race name is established as one of the plural races, and the one player name is assigned to the special race as a part of the race name thereof.

Preferably, race records of the respective racing members are evaluated in accordance with race results in a predetermined time period. Further, it is preferable that a ranking table in which the racing members are ranked in accordance with the race results is displayed so that the special race establisher determines the race name of the special race based on the name of a racing member first-ranked in the ranking table.

Preferably, the race is a horse races; the racing members are miniature racehorses; and the race record includes the number of prizes acquired by each miniature racehorse.

According to the above configurations, when a player has gained an excellent race record (high score) in a game, there is held a special race having a name including a player's registered name as a part thereof, attraction for participation in a game and the sense of achievement in a game are remarkably enhanced.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is an external perspective view showing a race game machine according to one embodiment of the present invention;

FIG. 2 is a block diagram showing a main controller of the racing game machine shown in FIG. 1;

FIG. 3 is a block diagram showing a station controller of the race game machine shown in FIG. 1;

FIG. 4A is a table showing player data;

FIG. 4B is a table showing magnetic card data;

FIG. 5 is a flowchart showing processing procedures of cycle control processing cyclically performed;

FIG. 6 is a flowchart showing processing procedures performed by a station controller after a magnetic card has been inserted;

FIG. 7 is a flowchart showing processing procedures for rearing virtual racehorses;

FIG. 8 is a diagram showing a cycle of progress in a racing game;

FIG. 9 is a flowchart showing collation processing procedures;

FIG. 10 is a flowchart showing data update processing procedures;

FIG. 11 is an illustration showing a player registration screen;

FIG. 12 is an illustration showing a racehorse purchase screen;

FIG. 13 is an illustration showing a race selection screen;

FIG. 14 is an illustration showing that horses for entry have been registered on the race selection screen;

FIG. 15 is an illustration showing a training method selection screen;

FIG. 16 is an illustration showing a betting screen;

FIG. 17 is an illustration showing a user information display screen;

FIG. 18 is an illustration showing an operation screen for causing a virtual racehorse to retire;

FIG. 19 is a record display screen concerning an honored horse;

FIG. 20 is a flowchart showing special race establishment processing procedures;

FIG. 21 is an illustration showing a race selection screen in which a special race is established; and

FIG. 22 is an illustration showing a betting screen in which the special race is established.

### DETAILED DESCRIPTION OF THE PREFERRED EMBODIMENTS

One preferred embodiment of the present invention will now be described by reference to the accompanying drawings.

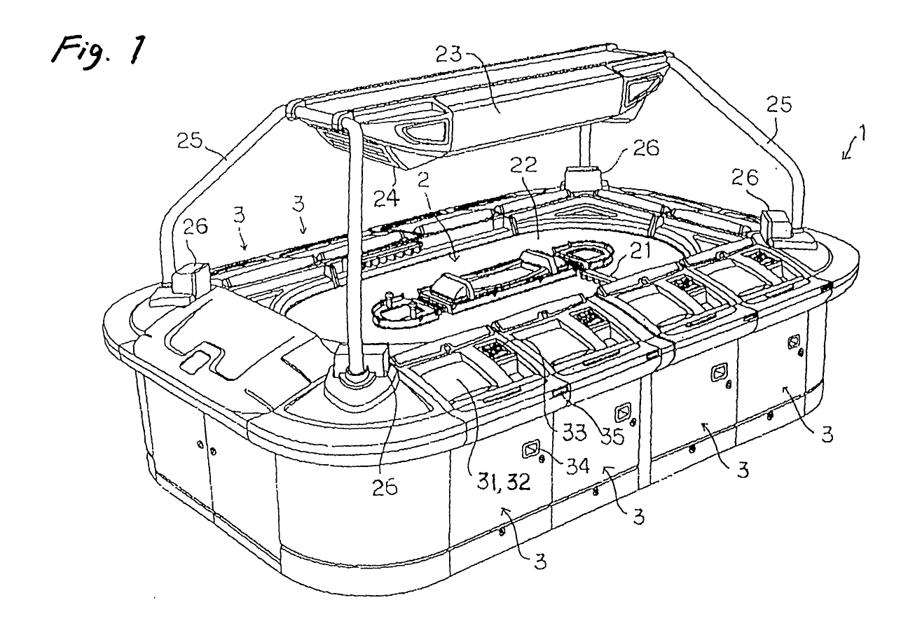

FIG. 1 is an external perspective view of a racing game machine. In the present embodiment, there will be described a racing game machine applied to a horseracing game. However, the present invention can be applied to other racing games, e.g., a dog race, a boat race, and a car race. Racing game machines of these types are embodied as token game machines installed in an amusement arcade.

As shown in FIG. 1, a racing game machine (hereinafter called a “game machine”) 1 comprises a field 2 provided in the center part thereof and a plurality of stations 3 provided so as to surround the field 2.

A racetrack 22 of a concourse having a gate 21 is provided in the field 2. A race closely resembling a real horserace is effected by causing a plurality of horse miniatures (not shown) to run on the racetrack 22. Disposed around the field 2 are speaker systems 26 for outputting sounds of live call of a race.

Each of the stations 3 is provided with a display 31 for displaying a game screen corresponding to progress in a game, and a touch panel 32 laid over a display screen of the display 31. When a player has touched a predetermined position on the game screen appearing on the display 31 in accordance with an instruction indicated on the game screen, the position of a touched area is detected by the touch panel 32. As a result, the game machine 1 perceives the nature of the player's operation.

Each of the stations 3 has a token slot 33 into which the player inserts a game token serving as a game value, a payout port 34 by way of which game tokens are paid out to the player, and a card slot 35 which enables insertion of a magnetic card.

As shown in FIG. 1, display sections 23 for displaying the title of a game and a lighting system 24 for illuminating the field 2 are supported on posts 25 in an elevated position above the field 2.

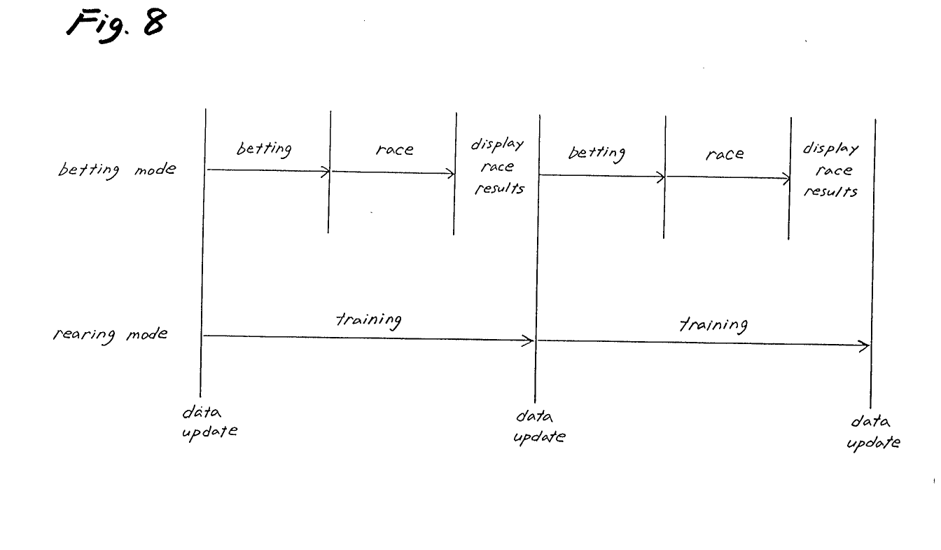

The outline of a game to be effected by the game machine 1 will now be described. The game machine 1 sequentially holds horseraces identical in name with real horseraces at predetermined intervals. About 60 horseraces are prepared for one year. As shown in FIG. 8, for each horserace, there are ensured a betting time, that is a time to purchase a betting ticket, a time to effect a horserace using horse miniatures, and a time to display a result of the race. A time during which a horserace is held changes in accordance with the distance of an individual race. Races for one year are completed within about two hours. After the races have been completed, races for the next year are successively started.

The player predicts a finish order for each horserace and can freely purchase a betting ticket. The player purchases a betting ticket by betting game tokens. If a match exists between the thus-purchased betting ticket and the race result, game tokens are paid as a payoff in an amount (number) corresponding to the number of game tokens bet and to odds. Here, purchase of a betting ticket means an action of betting game tokens on a predicted finish order.

A player can also participate in a game as an owner. More specifically, a player selects a preferred horse from among a plurality of racehorses prepared beforehand and can purchase the horse by paying a predetermined number of game tokens. Moreover, the player can select at his own will a stable for the thus-purchased horse. The name of the purchased horse is created, by combination of a name selected from among the names stored in the game machine beforehand with a name entered by the player (e.g., the name of the player). The player can train the purchased horse and can cause the horse to enter a desired race. At the time of entry of a race, the player can select a jockey.

In order to ensure consistency of a game when the player participates in a game, the game machine I employs a magnetic card having stored therein an ID code assigned to the player. Results of the games played by the player in the past are stored in the game machine 1 as player data. By matching the ID code stored on the magnetic card with the player data recorded in the game machine 1, required player data are loaded and used for a game. By carrying the magnetic card, the player can enjoy continuation of the game at all times.

As mentioned above, horseraces are run continuously according to a real schedule of horseraces. The player can purchase a betting ticket for an arbitrary race as an audience, as well as participating in a race by purchasing and training racehorses as an owner.

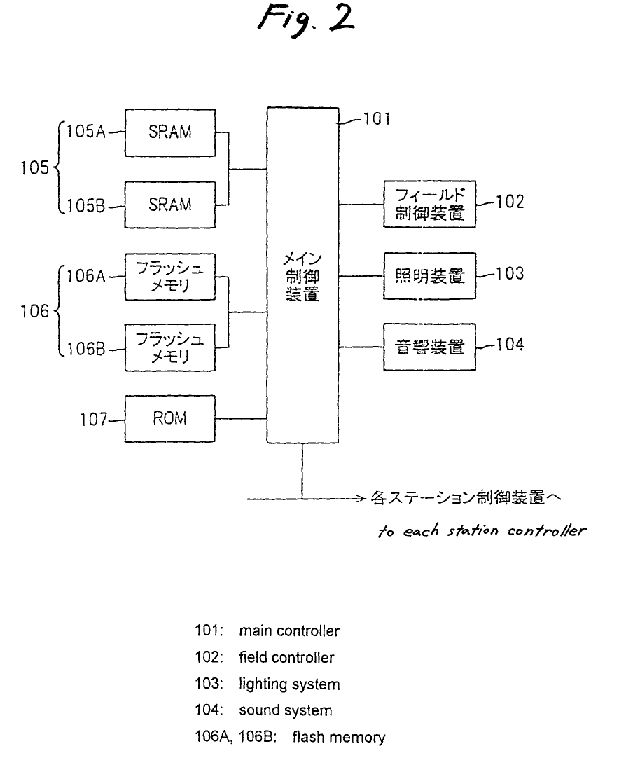

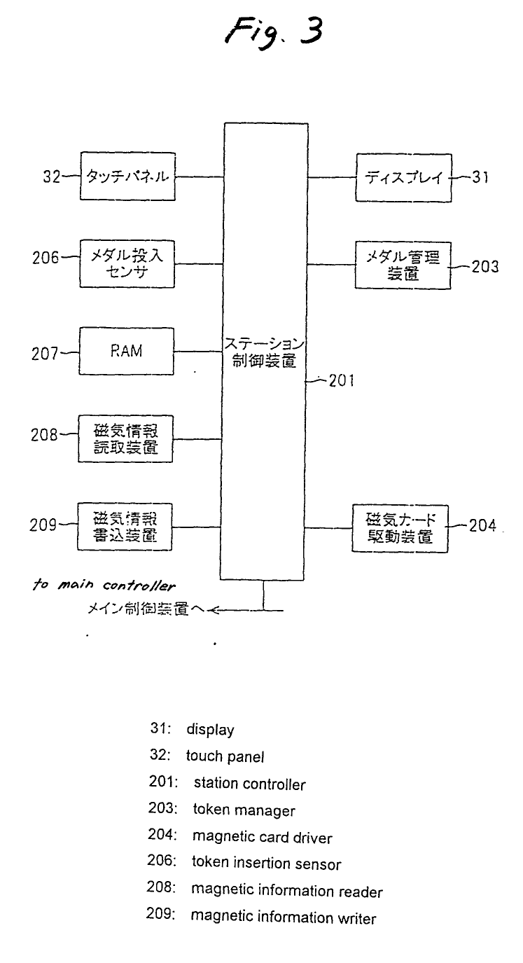

FIG. 2 is a control block diagram showing a main controller for controlling operations of the game machine 1 in a consolidated manner. FIG. 3 is a control block diagram showing a station controller provided for each of the stations 3.

As shown in FIG. 2, a main controller 101 is provided with a field controller 102 for controlling running actions of horse miniatures in the field 2; a lighting system 103 for illuminating the field 2; a sound system 104 for generating sounds for reproducing the atmosphere of a concourse; SRAM 105 and flash memory 106 for storing player data; and ROM 107 having stored therein a program required for effecting a game and various types of databases. The sound system 104 has a speaker system 26 (shown in FIG. 1). The database stored in the ROM 107 includes, e.g., 256 types of horse names to be selected by a player, sound data pertaining to the horse names, various types of data pertaining to respective horses, and a race schedule.

As shown in FIG. 2, the main controller 101 is connected to the field controller 102, the lighting system 103, the sound system 104, the SRAM 105, the flash memory 106, and the ROM 107.

The power of the SRAM 105 is backed up at all times by batteries. Two modules of SRAM 105 and two modules of flash memory 106 are provided, and identical data are stored in both modules of memory. Hence, in the event that data stored in one of the two modules of memory are corrupted, the data are not lost. More specifically, as shown in FIG. 2, the SRAM 105 comprises two modules 105A and 105B, and the flash memory 106 comprises two modules 106A and 106B. Consideration is given to use of the remaining module as a backup in the event that one of the modules becomes faulty or replaced.

As shown in FIG. 3, for each station 3, a station controller 201 is provided with the display 31; a token manager 203 for managing payout of tokens; a magnetic card driver 204 for driving a magnetic card inserted into the card slot 35; the touch panel 32; a token insertion sensor 206 for detecting the tokens inserted by way of the token slot 33; RAM 207 for temporarily storing player data; a magnetic information reader 208 for reading magnetic information stored on the magnetic card inserted into the card slot 35; and a magnetic information writer 209 for writing magnetic card information into the magnetic card.

Further, as shown in FIG. 3, the station controller 201 is connected to the display 31, the token manager 203, the magnetic card driver 204; the touch panel 32; the token insertion sensor 206; RAM 207; the magnetic information reader 208; and the magnetic information writer 209.

As shown in FIGS. 2 and 3, the station controller 201 of each station 3 is connected to the main controller 101, and required communication can be established between the station controller 201 and the main controller 101.

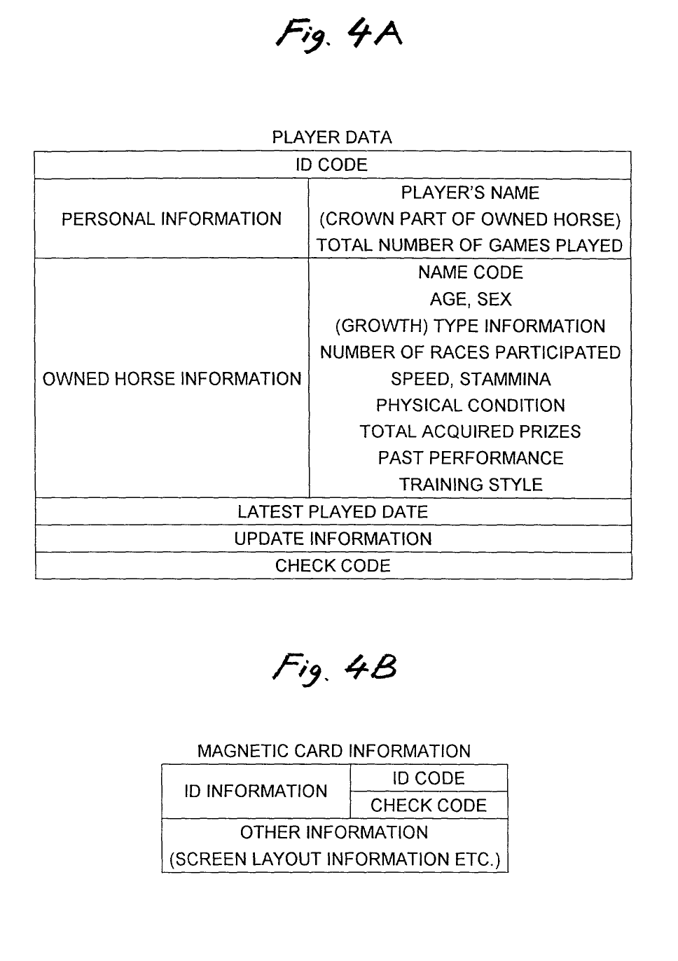

FIG. 4A shows a data structure of player data to be stored and managed for each player. The player data include information about the status and history of games. As shown in FIG. 4A, the player data comprise an ID code assigned to each player; personal information pertaining to the player; horse information pertaining to a horse owned by the player; latest played date information for identifying the latest date on which the player has played the game; update information for recording data update; and check code for preventing falsification of a magnetic card.

In the present embodiment, the ID code and the check code are used as ID information. Here, the ID code is a number assigned to an individual player and is set so as to prevent establishment of an overlap between one player data set and another player data set. Personal information pertains to an individual player, such as the name of a player and a total number of games played. Personal information is used as reflecting on details of a game and also as client management data. The player's name is used also as the crown part of a name of his/her owned horse, the name being included in the horse information.

The horse information is provided for each horse and comprises a name code for identifying the name of a horse; the sex of the horse; horse type information specified as a growth curve; an age; the number of races the horse has participated; speed; stamina; physical condition; total acquired prizes; records of respective races held in the past (e.g., win, second place, or also-ran); and a training style determined by a selected stable.

The latest played date indicates a date on which the player played a game most recently using the player data. More specifically, the latest played date indicates the number of days which have elapsed from, e.g., Jan. 1, 2000. Since inconsistency between the latest played date and the player data can be ascertained through comparison, data pertaining to the latest played date can be used for protecting against fraud. The personal information, the horse information, and the latest played date information are used as a game history for ensuring continuation of an interrupted game.

Update information is a numerical value which is incremented each time player data are updated through training operation to be described later. In normal times, when player data are updated in the station 3 on the basis of a game result, an even value is stored as update information. However, if the most recent update of the player data has been effected by the main controller 101 for any reason, e.g., accidents in the station 3, the numerical value assumes an odd value until the next update operation.

The player data are stored in the SRAM 105 or the flash memory 106. When the player plays a game at the station 3, required data are loaded into the RAM 207 of a corresponding station 3 and used for various processing operations to be performed by the station 3.

The check code is an error detection code and is prepared on the basis of various data sets, such as an ID code, personal information, horse information, a latest played date, and update information. The check code is used for checking an item, such as whether or not there is falsification of or trouble in a magnetic card or whether or not the communication of player data between the station 3 and the main controller 101 is successfully conducted.

FIG. 4B shows ID information to be recorded on a magnetic card. The ID information is used for identifying a player. As shown in FIG. 4B, the ID information consists of an ID code and a check code, both belonging to ID information. The remaining data sets constituting the player data are not recorded on the magnetic card, thereby preventing establishment of fraud, which could otherwise be caused by falsification of magnetic card information. As shown in FIG. 4B, layout information pertaining to a screen irrelevant to progress in a game and information not used for preparing an error detection code can also be recorded on a magnetic card.

An example operation of the game machine 1 will now be described. Input operations which are performed by the player in accordance with an indication on the display 31 are perceived by the station controller 201 on the basis of a signal output from the touch panel 32. In the following descriptions, explanation of processing performed for perceiving individual input operations is omitted.

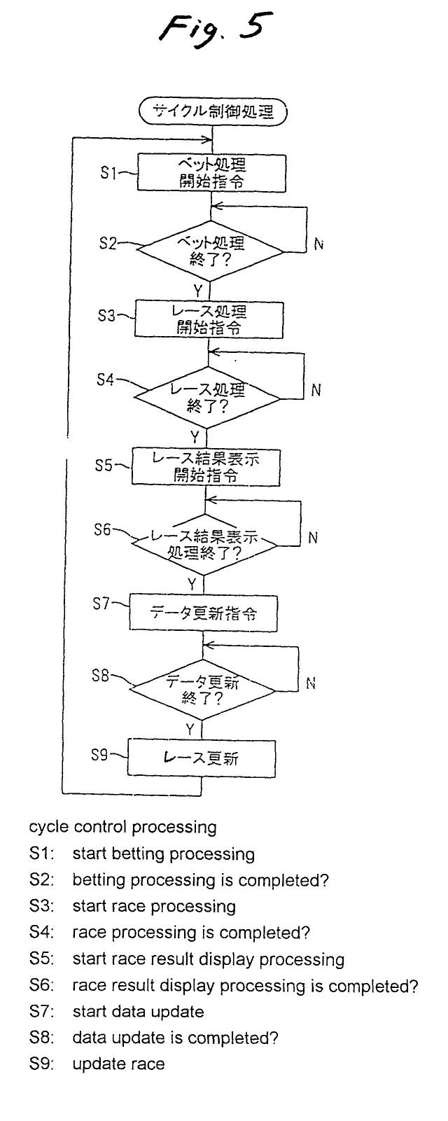

FIG. 5 is a flowchart showing cycle control processing performed by the main controller 101. The cycle control processing is for effecting annual races in a predetermined sequence and indicating switching timings of respective processings included in each of races.

During cycle control processing, the main controller 101 performs control operation for each race so as to sequentially effect the following processing operations:

(1) Betting processing: namely, processing for purchasing a betting ticket;

(2) Race processing for effecting a race by causing horses to enter into the race;

(3) Race result display processing for displaying a finish order of horses in a race and odds; and

(4) Data update processing for updating player data stored in the SRAM 105 by causing each of the stations 3 to transmit up-to-date player data.

Through the processing, actual annual races are sequentially performed in a predetermined order while one cycle (race) takes about two minutes. As shown in FIG. 8, rearing processing to be described later is performed during a predetermined period within the cycle. FIG. 8 shows a portion of the race cycle controlled by cycle control processing.

Next will be described in detail cycle control processing. Initiation of betting processing is instructed at step S1 shown in FIG. 5. Upon receipt of the instruction, the station controller 201 of each of the stations 3 performs betting processing. The termination time of betting processing is awaited in step S2, and processing proceeds to step S3.

Initiation of race processing is instructed in step S3. Upon receipt of the instruction, various types of processing (not shown) required for effecting operation of horse miniatures, such as running operation and output of required sound, are performed under control of the main controller 101. The termination time of race processing is awaited in step S4, and processing proceeds to step S5.

Initiation of race result display processing is instructed in step S5. Upon receipt of the instruction, the main controller 101 performs predetermined processing (not shown) for displaying on the display 31 the finish order of horses in a race, odds, and payouts. The termination time of race result display processing is awaited in step S6, and processing proceeds to step S7.

A data update instruction for updating player data is output in step S7, and completion of data update processing is awaited in step S8. Processing then proceeds to step S9. The race is updated to the next race in step S9, and processing returns to step S1. If a data update completion flag set during data update processing is set to ON, it is determined in step S8 that data update processing has been completed. The data update completion flag is set to OFF in step S9. The data update processing will be described later.

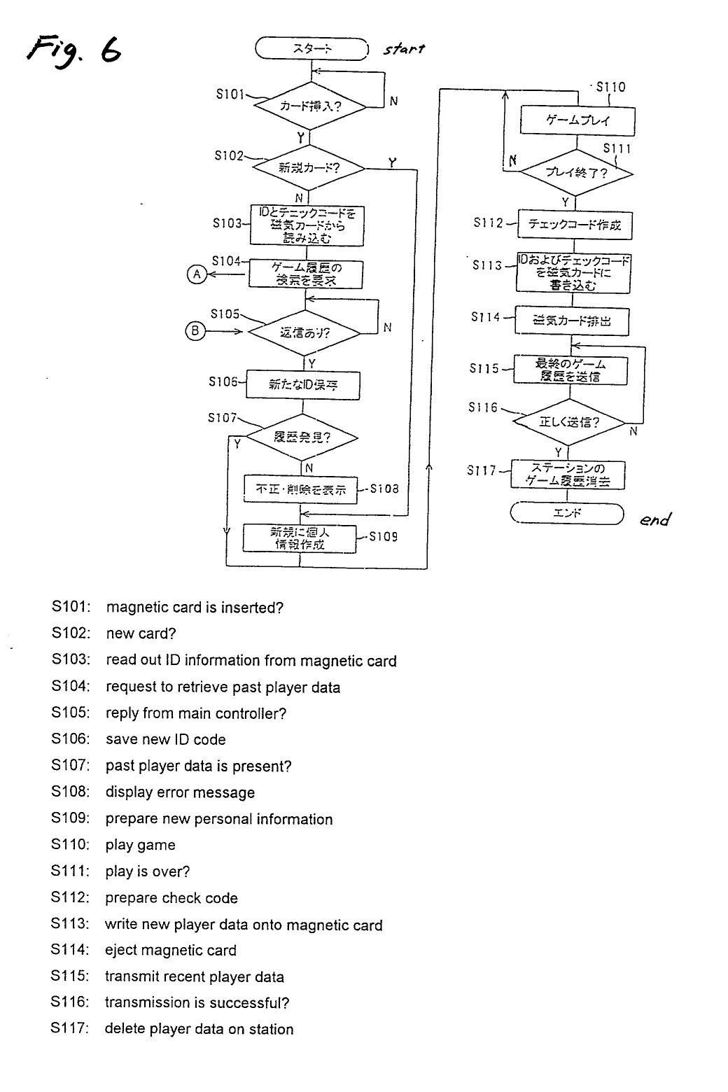

Referring to FIG. 6, there is described processing to be performed by the station controller 201 when a magnetic card is inserted into the card slot 35 of the station 3.

Insertion of a magnetic card into the card slot 35 is awaited in step S101 shown in FIG. 6, and processing proceeds to step S102, where a determination is made as to whether or not the thus-inserted magnetic card is a new card. If an affirmative determination is made, processing jumps to step S109. In contrast, if a negative determination is rendered, an ID code and a check code are loaded from the magnetic card in step S103, by controlling the magnetic card driver 204 and the magnetic information reader 208.

The ID code and the check code recorded on the inserted magnetic card are transmitted to the main controller 101 in step S104. Further, there is issued a request to the main controller 101 for retrieving player data assigned the same ID code as that recorded on the magnetic card. Upon receipt of the request, the main controller 101 retrieves an ID code (“A” in FIG. 6), and the processing will be described later.

A reply from the main controller 101 is awaited in step S105, and processing proceeds to step S106. A new ID code transmitted from the main controller 101 is saved in the RAM 207. The reply from the main controller 101 will be described later (“B” in FIG. 6).

If it is determined in step S107 that the result of retrieval performed by the main controller 101 reveals presence of player data assigned an identical ID, processing jumps to step S110. If it is determined that no player data assigned the identical ID is present, a message stating that the magnetic card is invalid or that past information has expired and been deleted is displayed on, e.g., the display 31, in step S108, thereby notifying the player. Personal information is newly prepared in subsequent step S109, and processing proceeds to step S110.

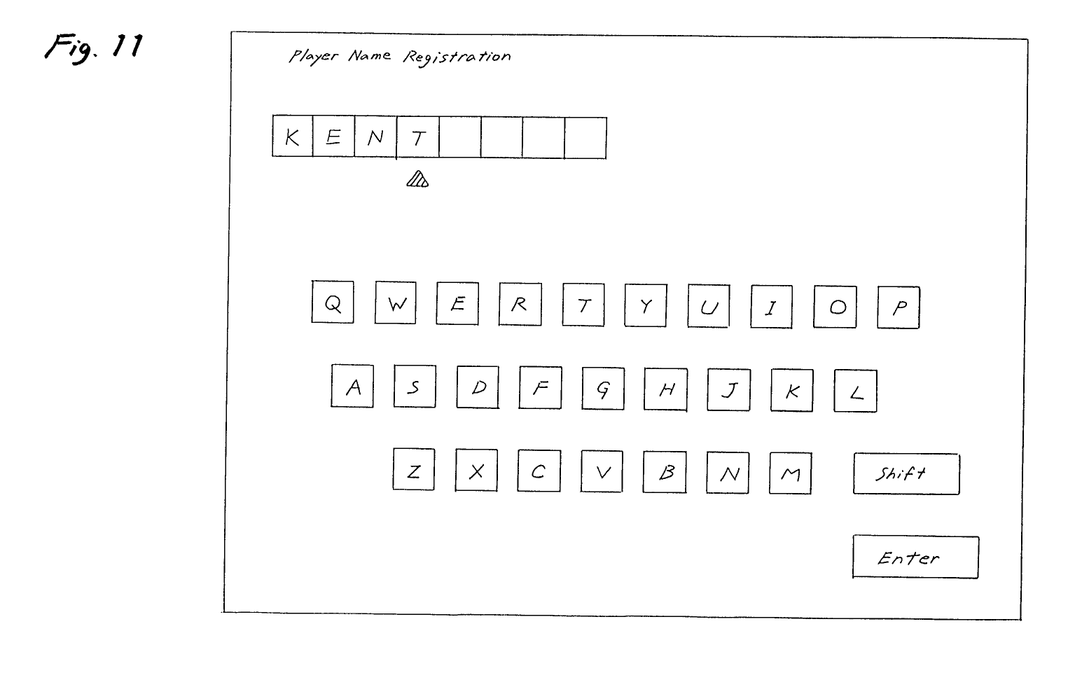

A person who attempts to newly participate in a horseracing game purchases a new magnetic card and inserts the card into the card slot 35. As a result, an affirmative determination is rendered in step S102, and processing jumps to step S109. First of all, a player name registration screen shown in FIG. 11 appears on the display 31 in step S109. The player enters on the registration screen a name which the player desires to register through use of a keyboard appearing on the screen. In the example, the player enters a name “Kent” through touching buttons of the keyboard. When an enter button is pressed, the name “Kent” is registered as the player's name.

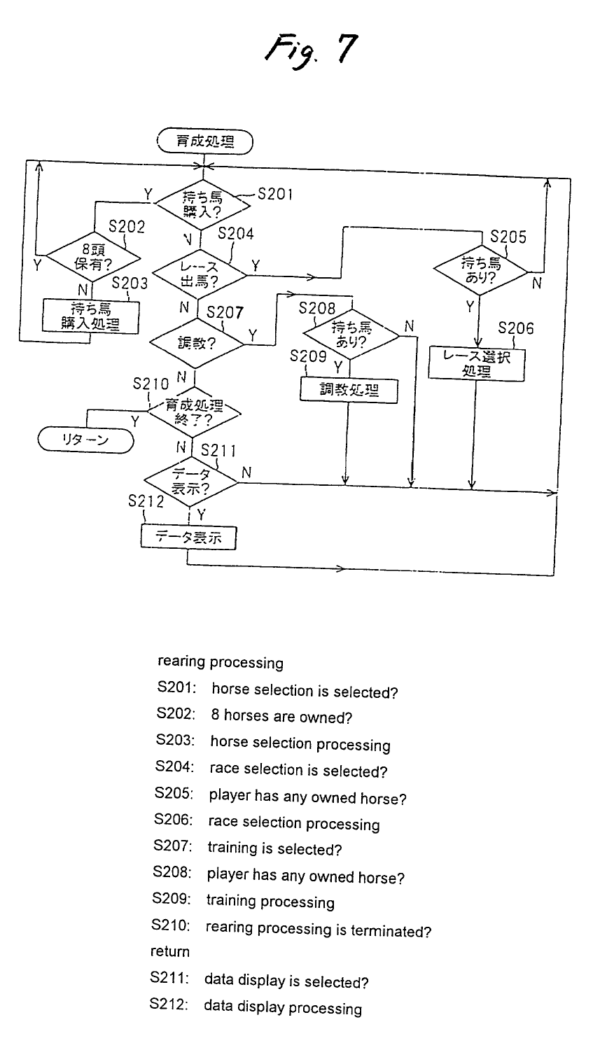

Processing required for the player to play a game is performed in step S110. Rearing processing (see FIG. 7) to be described later is included in this processing. Processing pertaining to step S110 is continued until it is determined in step S111 that playing of games ends.

If it is determined in step S111 that playing of games ends, a check code is prepared on the basis of up-to-date player data. A new (current) ID code and a check code are written to a magnetic card (step S113), and the magnetic card is ejected (step S114).

The status of the most recent game and a history (i.e., player data) stored in the RAM 207 are transmitted to the main controller 101 in step S115. If it is ascertained that proper transmission of the game status and the history has been ascertained (step S116), the player data are deleted from the RAM 207 in step S117. The processing shown in FIG. 6 is completed. The game status and history (player data) transmitted in step S105 are stored in the SRAM 105 and stored until the player plays games the next time.

Processing for training the horse purchased by the player will now be described. FIG. 7 shows a flowchart showing a rearing processing procedure to be effected by the station controller 201.

A determination is made in step S201 shown in FIG. 7 as to whether or not the player has performed an operation for selecting purchase of a horse. If so, processing proceeds to step S202. By reference to the player data stored in the RAM 207, a determination is made in step S202 as to whether or not the player already owns eight horses. If so, processing returns to step S201. If not, processing proceeds to step S203. If the player already owns eight horses, the game machine 1 inhibits the player from purchasing another horse.

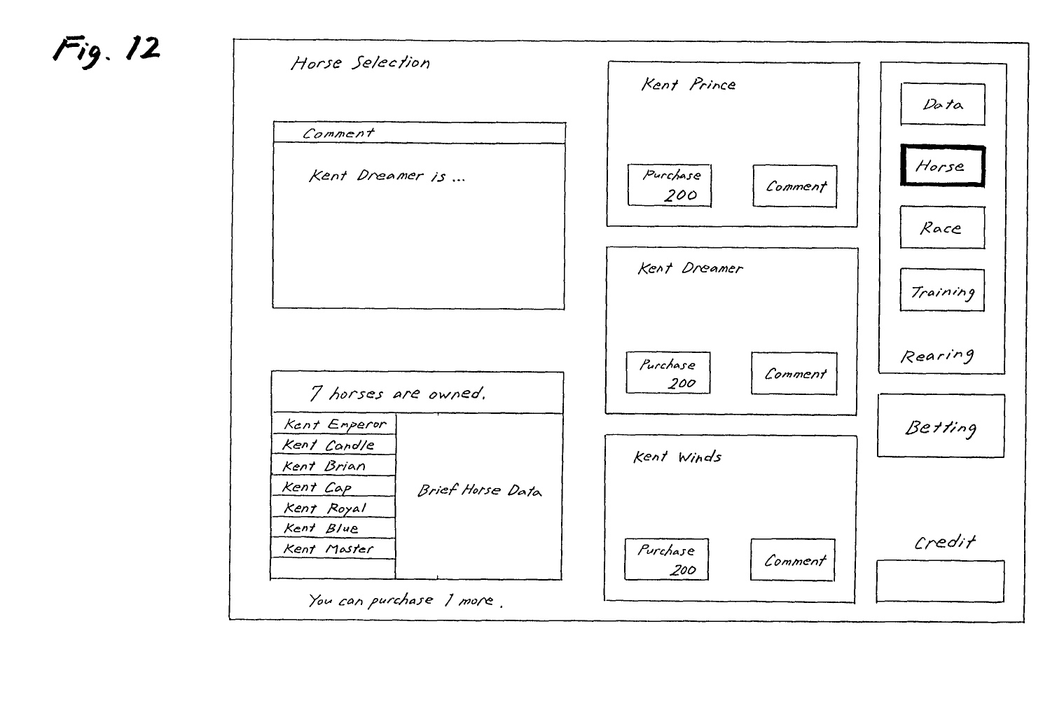

Processing for causing the player to purchase a horse is effected in the horse selection processing step S203. By reference to the player data stored in the RAM 207, a horse selection screen shown in FIG. 12 is displayed on the display 31 through the processing.

The horses are already owned by the player are listed in a left-side area on the horse selection screen (FIG. 12 shows seven horses). Brief information of each hoses such as sex, age and total amount of acquired prizes is displayed in a brief horse information area appearing in the right side of the owned horse list area. Information about three horses is displayed in a right-side area on the screen as candidates for purchase. The player's name entered on the screen shown in FIG. 11 is employed as the crown part of the name of a horse. As a result, the player tends to feel deeper affection for his/her horse, and the name also facilitates distinction between the player's horse and horses of other players.

The name of the horse is output as sounds via the sound system 104 in a live call at the time of entry into a race, thus enhancing presence of a race. The name of a horse is prepared by combination of the crown part registered as a player's name with a horse name selected from predetermined 256 types of horse names. By outputting the combined horse names as sounds, natural sounds output in live call are made feasible while unique horse names which do not overlap horses of the other players are ensured. The names of the owned horses are stored as player data in the RAM 207.

A bet button indicating the number of game tokens required for purchasing a horse is displayed in an area assigned to each of candidate horses. A comment about one of the indicated candidate horses is indicated in an upper portion of the left-side area on the screen (i.e., a horse display area). The comment appears when the player touches a comment button about a corresponding horse.

The screen shown in FIG. 12 shows information about three horses which are candidates for purchase. The number of horses to be displayed may be set to a higher value. By sequentially switching candidates to be displayed at a predetermined timing or through the player's operation, the number of horses which can be selected can be incremented.

When a purchase button indicating the number of game tokens is touched by the player, a horse corresponding to the purchase button is selected and purchased. The number of game tokens to be paid by the player at the time of purchase of a horse is set to a value corresponding to the ability of an individual horse. The stronger a horse, the greater the number of game tokens. The example shown in FIG. 12 shows three horses, each assigned 200 bets.

A growth type, such as a precocious type or a late bloomer, and an aptitude for distance are set as information about candidate horses for purchase. The player can select a training method suitable for the characteristic of a horse or a horse which enters a race. As indicated by the processing pertaining to step S202, the player cannot own nine or more horses.

Horses to be displayed in the right-side area on the screen shown in FIG. 12 can be changed for each station 3. Horses to be displayed may be changed in accordance with the player's current credit. For instance, a larger number of horses of low purchase prices may be indicated for stations 3 having lower credit, and a larger number of horses of high purchase prices may be indicated for stations 3 having greater credit. Alternatively, only horses which can be purchased by the player's current credit may be displayed for the respective stations 3. Thus, the number of horses to be displayed is diminished by changing the number of horses to be displayed in accordance with the player's credit, thus simplifying a screen display. Since only horses which can be purchased by the player are displayed, operations required to be performed by the player also become simple. The number of credits currently possessed by the player is indicated in a rectangular area “CREDIT” appearing in a lower right corner of the horse selection screen.

Purchase of a horse is stored by updating the player data stored in the RAM 207.

As shown in FIG. 12, indicated in the right end on the screen is buttons for switching a play mode (i.e., a “betting” ticket purchase mode and a horse “rearing” mode) in the station 3. By the player touching the buttons, switching is effected to a mode corresponding to the touched button. A predetermined game screen corresponding to the mode appears on the display 31. Switching between a “data” display constituting a rearing mode, “purchase” of a horse, a “race” entry mode, and a “training” mode is effected by touching a corresponding button.

By reference to the player data stored in the RAM 207, an unillustrated stable selection screen is displayed on the display 31 after purchase of a horse. Through stable selection operation, the player can select any one from three types of stables; e.g., a regular stable, a stamina stable, and a speed stable. For instance, when a stamina stable is selected, a horse is trained as a long-distance type. When a speed stable is selected, a horse is trained as a short-distance type, When a regular stable is selected, a horse is trained as an average type, wherein the horse is biased toward neither a long distance type nor a short distance type.

Selection of a stable is stored by rewriting the player data stored in the RAM 207.

After completion of the foregoing processing, processing returns to step S201 from S203 (FIG. 7).

If a negative determination has been rendered in step S201, processing proceeds to step S204, where a determination is made as to whether or not the player has performed an operation for selecting a horse for race entry. Subsequently, if an affirmative determination is rendered in step S205, a determination is made as to whether or not the player already owns horses. If so, processing proceeds to step S206. If not, processing returns to step S201.

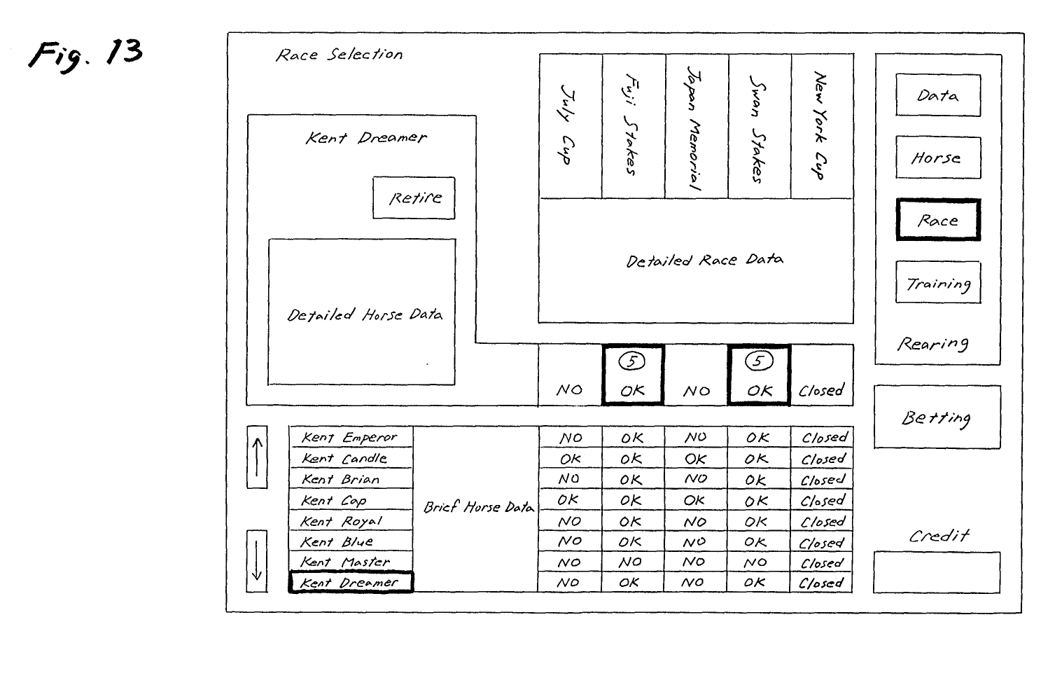

At step S206, there is performed processing for selecting a race which the player's horse is to enter. By reference to the player data stored in the RAM 207, a race selection screen shown in FIG. 13 is displayed on the display 31 through the processing. A table of horses owned by the player appears in a left-side area on the race selection screen. A display of owned horses can be vertically scrolled by the player touching a scroll button. Information about a currently-selected horse is displayed in an upper portion of the table display area.

Names of five races to be run from now (to be performed sequentially from the left) are displayed in an upper portion of a right-side area on the race selection screen shown in FIG. 13. Horses capable of entering a race are displayed for each of races in a lower portion of the right-side area on the race selection screen. Data such as a prize for first place or second place and entry requirements are displayed for each race in a race data area. Further, four types of statements are displayed; namely, “Registered” (this statement is not shown in FIG. 13) indicating that a corresponding horse has already been registered for entry, “OK” indicating that a corresponding horse is capable of entering a race, “NO” indicating that a corresponding horse does not satisfy entry requirements, and “Closed” indicating that entry registration has been closed. Thus, the player can ascertain whether or not each of his/her horses can enter a race.

The owned horse list can be scrolled by touching scroll buttons appearing in the left end of the screen. Information about a horse currently selected is displayed in an upper portion of the owned horse list (“Kent Dreamer” in connection with the example shown in FIG. 13).

A selected horse display area extends to a lower portion of a race table display appearing on the right side. A button indicating the number of game tokens, which the player has to pay as requirements for entry registration, is indicated in the extended area in connection with a race which a horse can enter, along with the four types of statements. In an illustrated example, the selected horse can enter a “Fuji Stakes” race and a “Swan Stakes” race. There is displayed a button indicating that five game tokens are required when the horse enter each of the races.

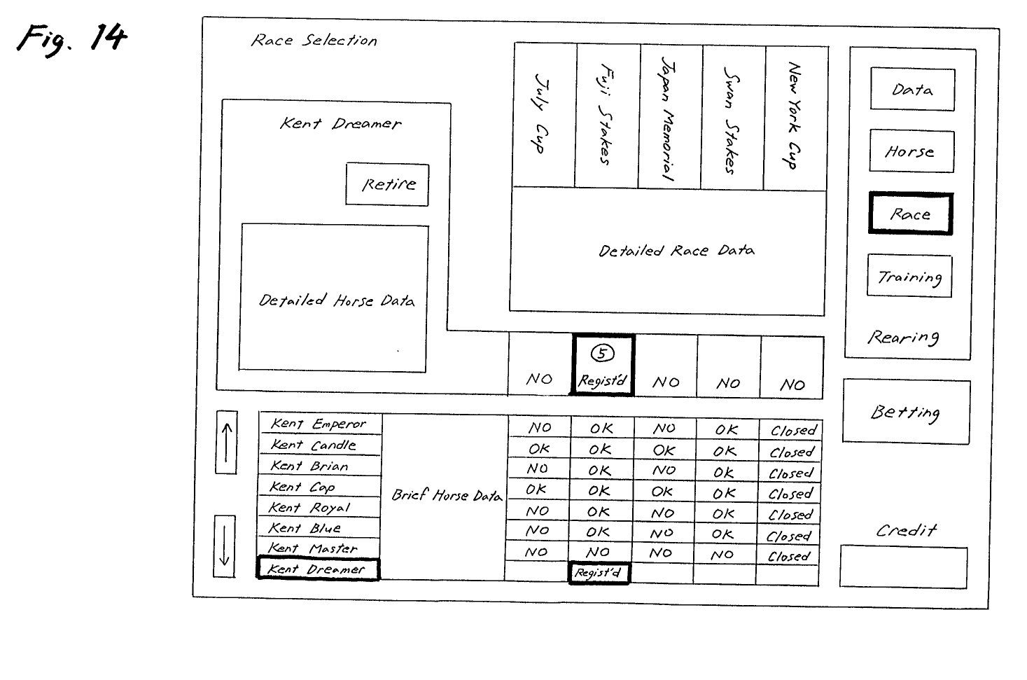

By the player touching a corresponding button, the selected horse is registered as entering a race corresponding to the touched button. For example, when the player has touched a button corresponding to a “Fuji Stakes” race in connection with the example shown in FIG. 13, a selected horse “Kent Dreamer” is registered as entering the “Fuji Stakes” race, as shown in FIG. 14.

A retirement button for determining whether to cause the selected horse to retire is provided in a detailed information display area assigned to the selected horse (e.g., “Kent Dreamer” in connection with the examples shown in FIGS. 13 and 14). If the player touches the retirement button, the selected horse can be caused to retire. Even if the selected horse has a great race record, the winning percentage of the horse decreases with age. Since a limitation is imposed on the number of horses the player can own (eight horse in the present embodiment), an aged horse must be caused to retire in order for the player to be able to purchase and rear a new horse.

When an entry race and the horse entering the race have been determined, a jockey who rides the thus-registered horse is selected. Since the capability of a jockey differs from one jockey to another, the selected jockey changes the winning percentage of a race. Each jockey has his own tactics, and compatibility of a jockey with the running characteristic of the registered horse must be determined. Hence, skill analogous to that required in a real horserace is demanded, thus enhancing the reality of a game. A percentage of allowance for a jockey and a horse riding style (a going-ahead type or a late-spurt type) are displayed on an unillustrated jockey selection screen along with the names of jockeys. The player selects jockeys by glancing at allowances for the respective jockeys and selects a jockey by touching a corresponding button.

Allowance corresponding to capability; that is, a percentage of allowance for a jockey when the horse on which the jockey rides has won a prize, is set for each jockey. For instance, a first-rate jockey has a high winning percentage, but allowance for the jockey is 60%, and allowance for the player is 40%. In the case of a third-rate jockey who has a low winning percentage, allowance for the player is set as 100%. In this case, if a race provides a prize of 200 game tokens, the player can acquire 80 game tokens when the player has won the race through use of the first-rate jockey. When the player has won the race through use of a third-rate jockey, he ca n acquire 200 game tokens.

As mentioned above, the player can select a jockey in consideration of not only victory or defeat in a game but also of a race. The horseracing game according to the present embodiment which enables various combinations of selection can offer a player a variety of ways to enjoy a game.

A jockey who rides a horse is stored by rewriting the player data stored in the RAM 207.

After completion of the foregoing processing (step S206), processing returns to step S201.

If a negative determination is rendered in step S204, processing proceeds to step S207, thus determining whether or not the player has performed an operation for selecting training of his horse. If an affirmative determination is rendered, processing proceeds to step S208, where a determination is made as to whether or not the player already owns horses, by reference to the player data stored in the RAM 207. If an affirmative determination has been rendered, processing proceeds to training processing pertaining to step S209. If a negative determination has been rendered, processing returns to step S201.

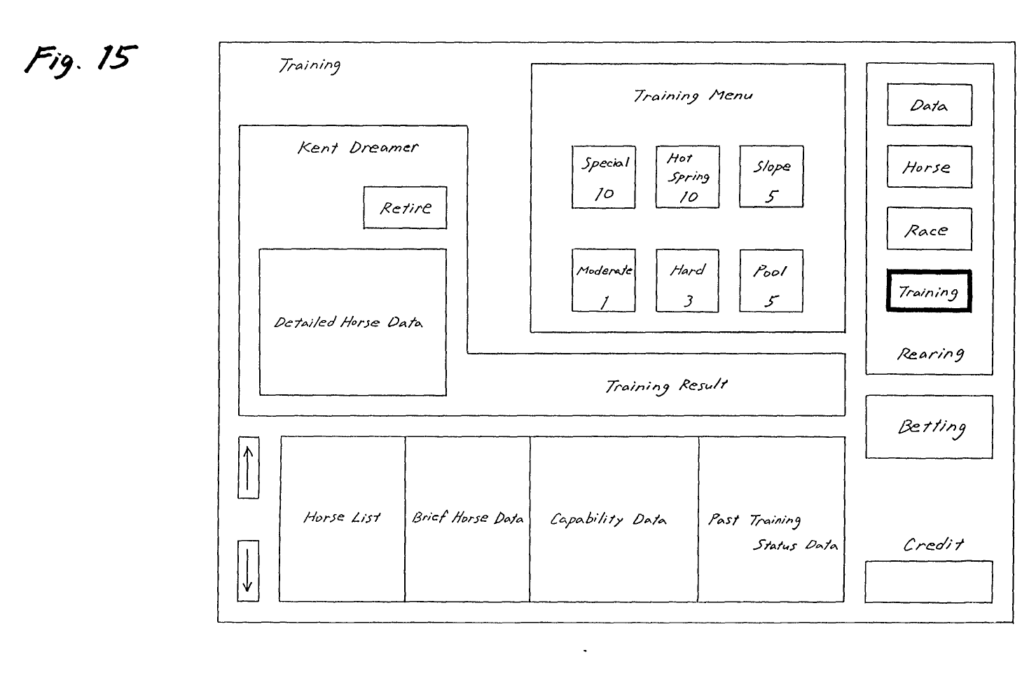

The training processing pertaining to step S209 will now be described. FIG. 15 shows a training processing screen.

Through the training processing, the horse owned by the player is trained by the player betting game tokens. The greater the number of game tokens bet, the more improved the capability of the trained horse. For instance, the player can bet one to three game tokens and obtain a result of training corresponding to the number of game tokens. The capability of a horse is improved by training the horse through betting of game tokens. Thus, the winning percentage of the race can be enhanced, and the player can train his/her horses as if saving money for the horses.

As mentioned above, in the present embodiment, the player can train his/her horses. Hence, the player can entertain himself/herself as if training his/her own horses to become stronger racehorses.

The capability of each horse is represented by a plurality of parameters (e.g., stamina, speed, and condition) and displayed in a capability data area appearing in the left side of the brief data area of each horse. Through the training processing, the player can select neither a parameter to be increased nor the extent to which a parameter is to be increased. In accordance with, e.g., a selected stable and the number of bets, the station controller 201 determines a parameter to be increased and the extent to which the value of a parameter is to be increased. As a result, training of a horse becomes feasible without involvement of complicated input operations.

Information regarding past training status for each horse such as a selected stable and previous training menu is displayed in a training data area appearing in the right side of the capability data area. Operating the scroll buttons, detailed information about a horse currently selected as an object of training is displayed in an upper portion of the owned horse list (“Kent Dreamer” in connection with the example shown in FIG. 15). Capability data concerning the horse are displayed also in the detailed horse data area as training results.

Selection buttons for selecting training menu are arranged in an upper right area on the training processing screen along with descriptions of the training menu. In the present embodiment, a “special” training, a “hot spring” training, a “slope” training, a “moderate” training, a “hard” training, and a “pool” training are prepared. The number of bets required for respective trainings are displayed.

For instance, when a “hot spring” training is selected, a horse reposes in a hot spring. When a “moderate” training has been selected, there is effected a training operation for increasing capability less with involvement of less fatigue. When a “hard” training has been selected, there is performed a training operation for increasing capability as compared with the case of the “moderate” training, with involvement of greater fatigue.

After completion of the rearing processing such as that mentioned above, processing returns to step S201 (see FIG. 7).

As shown in FIG. 8, rearing processing pertaining to step S209 is effected only during a period of time from when betting processing is started until the next betting processing is started. Rearing processing is forcefully terminated as a result of the start time of next betting processing having reached, and processing returns from step S209 to step S201. Only one training operation can be performed for each period, and the game machine 1 is constructed such that two or more training operations cannot be iterated. Hence, the player cannot quickly train his/her horse while neglecting lapse of time predicted from a race cycle, thereby imparting reality to the speed of training of a horse.

The selected training menu and a result of the thus-selected training are stored by rewriting the player data stored in the RAM 207.

If a negative determination has been rendered in step S207, processing proceeds to step S210. In step S210, a determination is made as to whether or not the completion of rearing processing has been selected by the player's operation. If not, processing proceeds to step S211.

In step S211, a determination is made as to whether or not data display processing has been selected by the player's operation. If so, processing proceeds to data display processing pertaining to step S212. If not, processing returns to step S201.

Through data display processing pertaining to step S212, a table of victories and defeats in a graded race and a record of a leading jockey are displayed on the data display screen (not shown). Further, a table of victories and defeats of the player's horses, the names of the horses, the ages and sexes of the horses, and records of the horses in the past races are also displayed. After completion of processing pertaining to step S212, processing returns to step S201.

If an affirmative determination is rendered in step S210, processing proceeds to step S111 (shown in FIG. 6).

The data display processing set forth is effected by referring to the player data stored in the RAM 207.

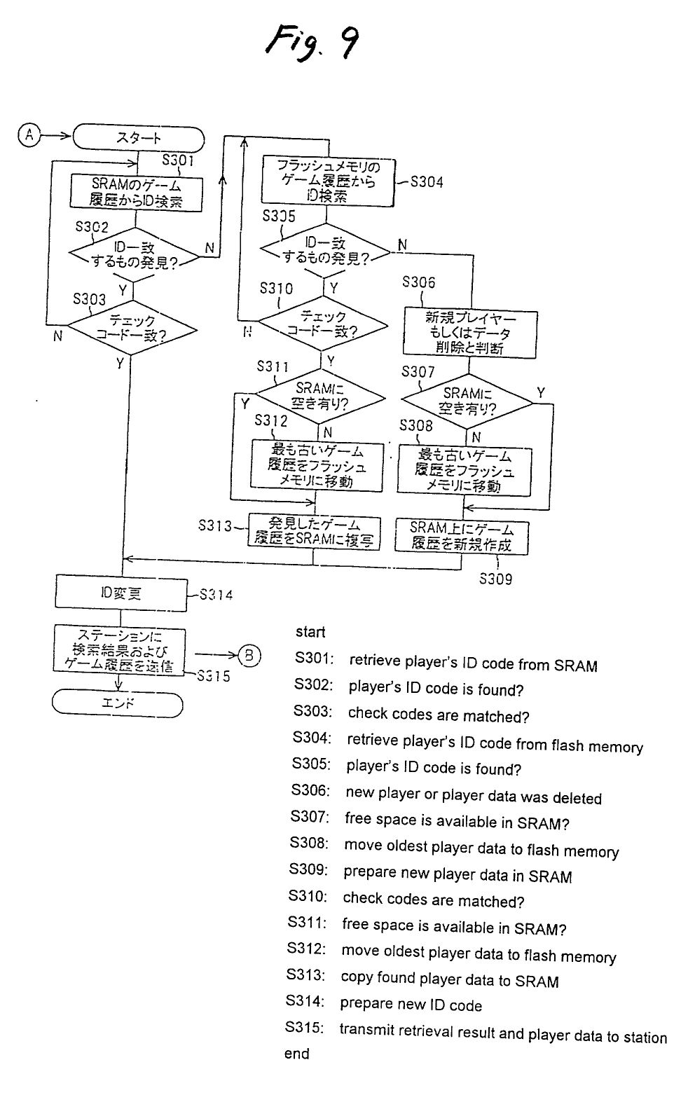

After a method of preserving player data has been described, processing shown in FIG. 9 and data update processing (shown in FIG. 7) will be described.

The game machine 1 has two storage devices; that is, the SRAM 105 and the flash memory 106, as areas where player data (see FIG. 4A) are to be saved. Although the SRAM 105 is comparatively expensive in terms of per-capacity unit price, the SRAM 105 enables high-speed access and has a long life against rewriting operations. Therefore, in the present embodiment, player data which will be rewritten frequently are stored in the SRAM 105. In contrast, comparatively old player data, such as a latest played date in the past, are stored in the flash memory 106 which is less expensive in terms of per-capacity unit price and has large capacity.

In order to distribute player data to the area set forth, the SRAM 105 is used first as an area where player data are to be stored. When the capacity of the SRAM 105 has become deficient, the player data are sequentially transferred to the flash memory 106 in sequence from the oldest data, thereby creating space in the storage area of the SRAM 105. The player data stored in the flash memory 106 are manually deleted or automatically deleted after lapse of a predetermined period of time since the data were most recently updated. As a result, free space of the flash memory 106 is ensured. Desirably, a period during which preservation of player data is ensured is notified to a player as a game expiration date. A balance between a period during which player data are ensured, the capacity of the SRAM 105, and the capacity of the flash memory 106 is set so as to fall within an appropriate range, thereby enabling appropriate management of player data.

When the player has visited the game machine 1 again and has again used and updated the player data that have already been transferred to the flash memory 106, the player data are transferred to the SRAM 105 from the flash memory 106. If the player frequently plays games and player data are updated at short intervals, the player data are not transferred to the flash memory 106 and remain stored in the SRAM 105.

Collation processing will now be described by reference to FIG. 9. Collation processing is started by the main controller 101 when the station controller 201 has received the request issued in step S104 (see FIG. 6).

In step S301 shown in FIG. 9, the player data stored in the SRAM 105 are retrieved. In step S302, a determination is made as to whether or not there have been found player data including an ID code identical with that for which the retrieval request has been issued. If so, processing proceeds to step S303, where a determination is made as to whether or not a match exists between the check code transmitted in step S104 and the check code assigned to the player data retrieved from the SRAM 105. If so, processing proceeds to step S314. If not, processing returns to step S301.

If a negative determination has been rendered in step S302, processing proceeds to step S304, where the player data stored in the flash memory 106 are retrieved. In step S305, a determination is made as to whether or not there have been retrieved player data including an ID code identical with that for which the retrieval request has been issued in step S104. If so, processing proceeds to step S310, where a determination is made as to whether or not a match exists between the check code transmitted in step S104 and the check code assigned to the player data retrieved from the flash -memory 106. If so, processing proceeds to step S311. If not, processing returns to step S304. In step S311, a determination is made as to whether or not free space is available in the SRAM 105. If not, the player data which have not been updated for the longest period of time are transferred from the SRAM 105 to the flash memory 106 (step S312), and processing proceeds to step S313. If an affirmative determination has been rendered in step S311, processing skips to step S313. In step S313, the game status or history (i.e., player data) retrieved from the flash memory 106 are copied to the SRAM 105, and processing proceeds to step S314.

If a negative determination has been rendered in step S305, in step S306 a determination is made as to whether player data are new player data or the player data have already been deleted from the flash memory 106. Next, in step S307 a determination is made as to whether or not free space is available in the SRAM 105. If not, the player data which have not been updated for the longest period of time are transferred from the SRAM 105 to the flash memory 106 (step S308), and processing proceeds to step S309. If an affirmative determination has been rendered in step S307, processing skips to step S309. At step S309, the game status or history (i.e., player data) retrieved from the flash memory 106 are copied to the SRAM 105, and processing proceeds to step S314.

At step S314, a new ID code is prepared. In step S315, a new ID code, retrieval results, and the retrieved or newly-prepared player data are transmitted to the station controller 201, and the processing shown in FIG. 9 is completed. The ID code transmitted through processing pertaining to step S315 is stored in step S106 (see FIG. 6). Determination processing pertaining to step S107 and processing pertaining to step S108 are performed on the basis of details of the data transmitted in step S315.

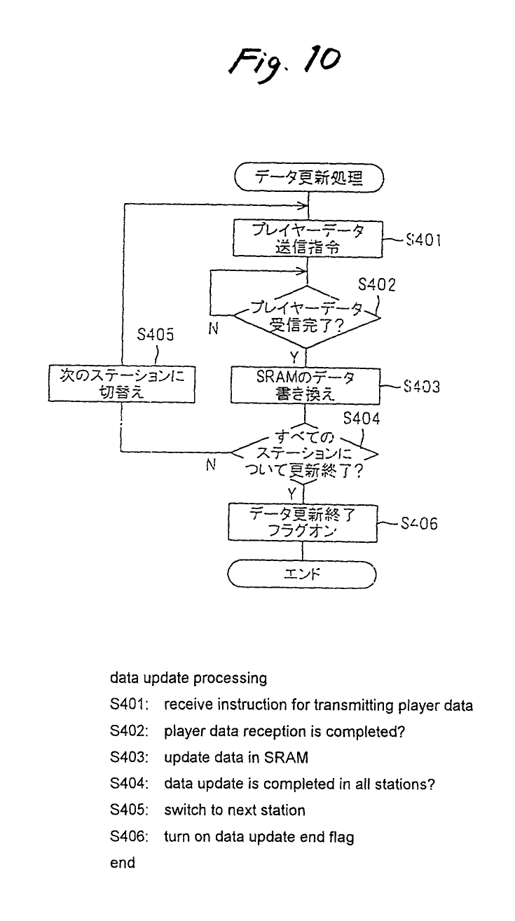

Data update processing will now be described by reference to FIG. 10. Upon receipt of the data update instruction issued in step S7, the controller 101 starts data update processing (see FIG. 5).

In step S401 shown in FIG. 10, an instruction for requesting transmission of player data; that is, a player data transmission instruction, is transmitted to the station controller 201 of each of the stations 3. Upon receipt of the player data transmission instruction, the station controller 201 of each of the stations 3 performs processing for sending player data to the main controller 101.

In step S402, receipt of player data from all the stations 3 is awaited, and processing proceeds to step S403. In step S403, player data stored in the SRAM 105 are rewritten with the player data transmitted from the station controllers 201 of the respective stations 3, and processing proceeds to step S404.

In step S404, a determination is made as to whether or not updating of player data has been completed, in connection with all the stations 3 that have transmitted player data to the main controller 101. If not, processing proceeds to step S405, where an object for which player data stored in the SRAM 105 are rewritten is switched to the next station 3. Processing then returns to step S401. If an affirmative determination has been rendered, a data update end flag is set to ON at step S406, and processing is terminated. As mentioned before, the data update end flag is an object for which a determination is made in step S8 during the cycle processing shown in FIG. 5. If the data update end flag is set to ON, processing proceeds to step S9 from step S8. Consequently, so long as update of player data pertaining to all the stations 3 has been completed, processing proceeds to the next race.

As mentioned above, in the present embodiment, a game history, which includes the status of a previous game, is stored as a player data. Hence, while the game machine 1 is in operation, the game machine 1 sequentially effects annual races. In terms of a game calendar, one year for games elapses within a few hours. Consequently, for example, when a player has finished playing a game at a March Prize race, visited the game machine 1 again a few days later, and resumed the game at a June Derby race, in terms of a race calendar tens of years have elapsed. At this time, if the player has resumed a game as time has elapsed in accordance with a game calendar as a result of operation of the game machine 1, only years of age are added to the player's horses without training them in for tens of years. As a result, the player will lose an interest in games.

In the present embodiment, lapse of a time in terms of a game calendar is managed independently for each player. In the foregoing case, the player is handled as having resumed a game at a June Derby race in the same year as that in which the player has participated in the March Prize race. Hence, the player's horses are deemed as having taken a rest for three months. Even if a game is interrupted, sufficient use of the capability of the player's horse can be made when the player resumes a game. The player can sufficiently enjoy an actual schedule of horseraces. Flow of a time in terms of a game calendar is not preferable. For instance, in a case where the player has interrupted a game at a June Derby race and resumed a game at a March Prize race, the player is deemed as having resumed a race from the March Prize race in the next year. Hence, the player's horses are handled as having remained at rest for nine months.

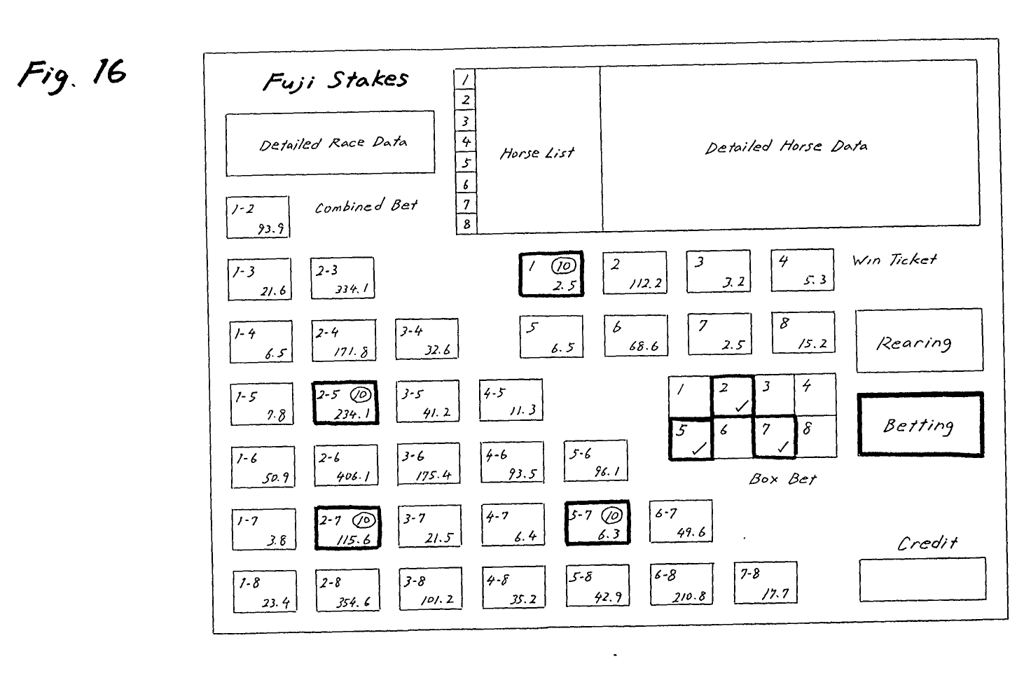

FIG. 16 shows a betting screen appearing on the display 31 during the betting processing. As mentioned above, the player can purchase a betting ticket for a race during the betting processing (see FIGS. 5 and 8). As shown in FIG. 16, the name of a race and detailed information thereof are displayed on an upper left corner on the betting screen, and information about horses which enter the race are listed in an upper right area on the betting screen with detailed information such as station numbers, expectations, jockeys, past records, conditions and odds. Ticket purchase buttons are arranged on the betting screen with odds of a race. Through the betting processing, a corresponding betting ticket can be purchased, by the player touching a desired ticket purchase button. The number of tokens bet by the player is indicated on the corresponding ticket purchase button.

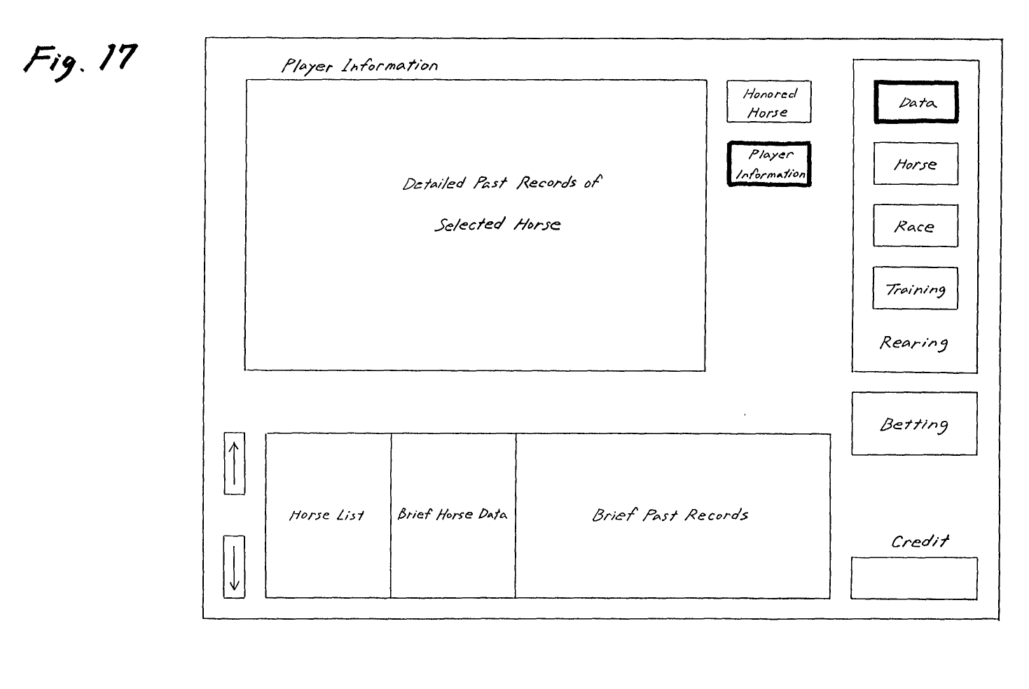

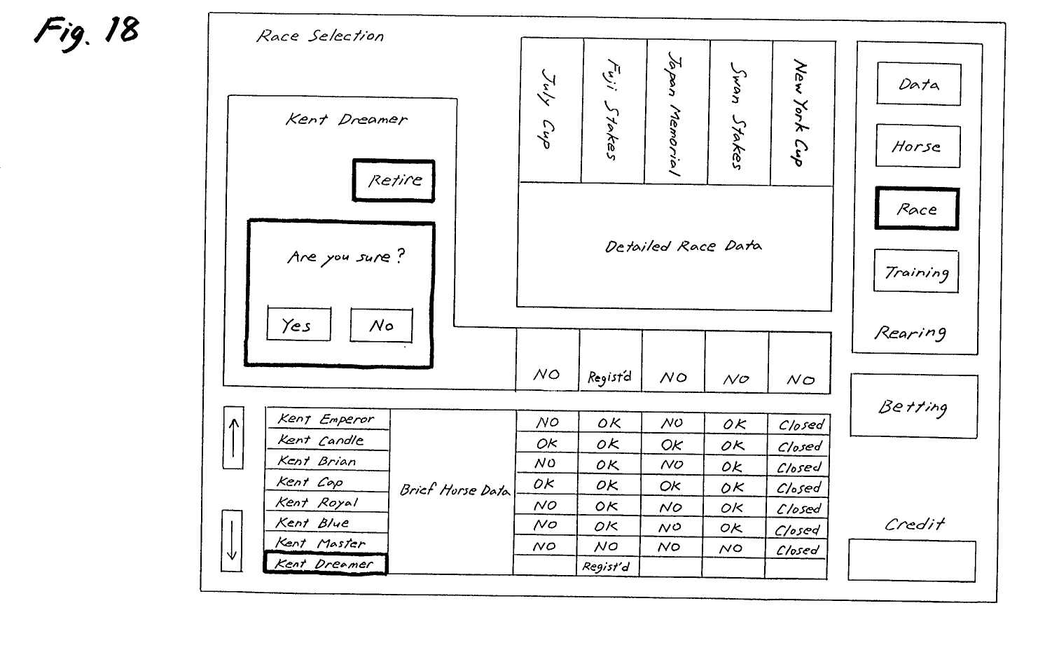

The player can have ascertained information about his/her horses (user information) at any time. FIG. 17 is an illustration showing an example user information display screen. The brief past record of each owned horse is displayed in the right side of the brief information area. Through use of the scroll buttons, the detailed past record of the selected horse, such as the status of a prize acquired in the graded race and information about betting tickets of high odds, are displayed in the form of a table. When the player desires to cause “Kent Dreamer” to retire, the player touches a “retire” button on any of the screens shown in FIGS. 13, 14, and 15. When the retirement button is pressed, a retirement ascertainment box appears in an upper left area on the screen, as shown in FIG. 18. When a “YES” button is pressed for ascertaining retirement, “Kent Dreamer” is caused to retire.

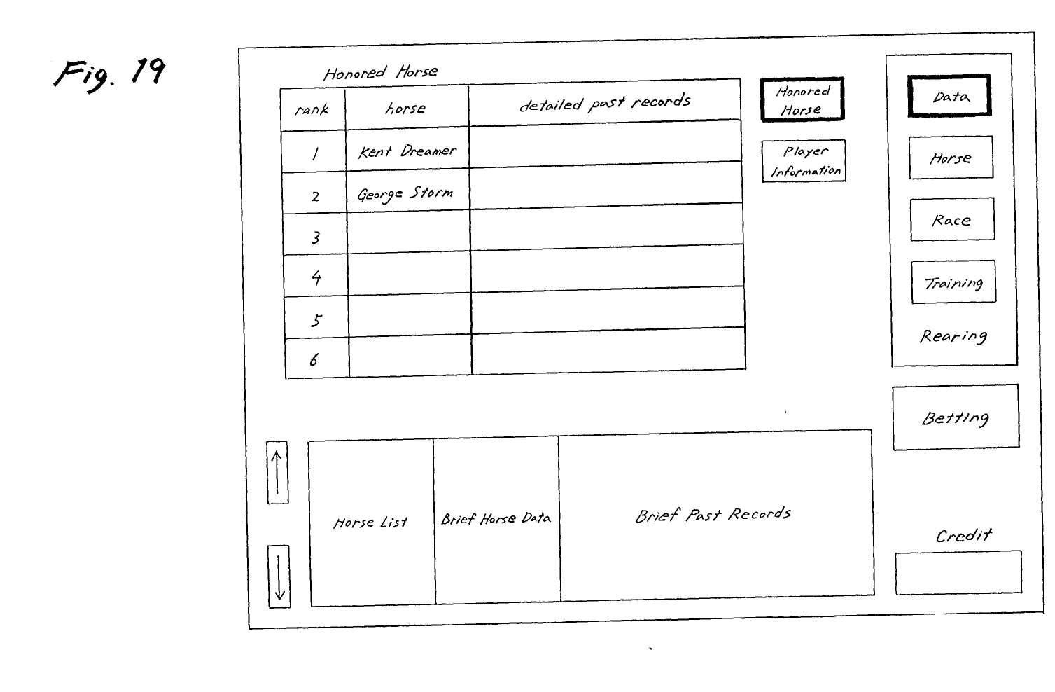

The player competes with fellow game players for prize money or the championship of G1 race. According to the game machine 1 according to the present embodiment, a horse which has been trained strong is ranked as a “honored horse.” If the player desires to glance at the ranking status of a horse, data pertaining to honored horses are displayed, as shown in FIG. 19. Before causing his horse to retire, the player refers to an honored-horse display screen shown in FIG. 19 so as to ascertain whether or not the horse is ranked first when the horse is caused to retire. In contrast with the game calendar, records of horses which are to be caused to retire in an “actual” present month are compared with each other. Standards for ranking are comprehensively determined in terms of acquired prizes, the number of winnings in G1 race, and a winning percentage.

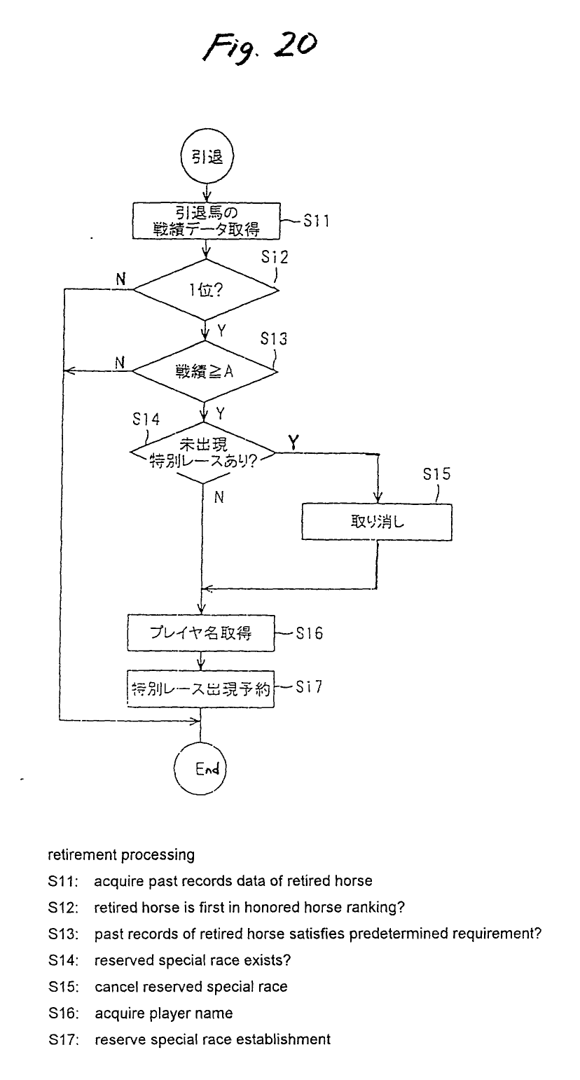

In the present embodiment, in order to honor a player who has trained the first-ranked horse, a special race is established. FIG. 20 is a flowchart showing processing procedures for effecting special race establishment processing. When the retirement button is pressed and depression of a retirement ascertainment button is effected, the special race establishment processing is initiated. Record data pertaining to other retirement horses which are objects of ranking and record data pertaining to a horse which is to retire at this time are loaded from memory (step S11). In step S12, a determination is made as to whether or not a horse which is to retire this time can turn out to be first, through comparison between a record of the horse and those of other retirement horses. When the horse becomes first, processing proceeds to step S13. In contrast, when the horse does not turn out to be first, the special race establishment processing is completed.

In step S13, a determination is made as to whether or not the first rank is suitable for holding a special race (e.g., whether or not the horse has acquired one or more prizes in G1 race and a total prize of 4000 tokens or more). If the first rank is not suitable for holding a special race, processing proceeds to a step S14. If records of the horse are not suitable for holding a special race, the special race establishment processing is terminated.

In step S14, a determination is made as to whether or not there is a special race which has not yet occurred. For example, as shown in FIG. 19, “George Storm” was ranked first before “Kent Dreamer.” If a special race entitled “George Memorial” has already been determined through the special race establishment processing shown in FIG. 20 but has not yet occurred, processing proceeds to step S15, where the “George Memorial” special race is canceled. Processing then proceeds to step S16. If there is no special race to be annulled, processing proceeds from step S14 to step S16.

In step S16, the player's name; that is, “Kent,” is extracted from horse “Kent Dreamer” currently ranked first. At step S17, establishment of a special race entitled “Kent Memorial” is reserved, and the current special race establishment processing is terminated.

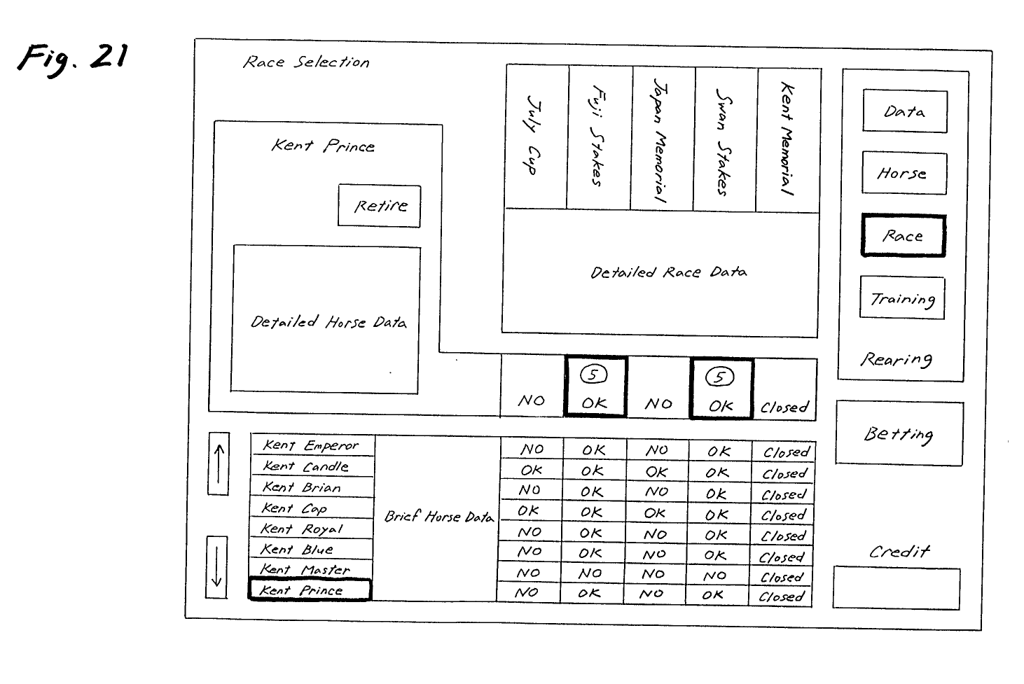

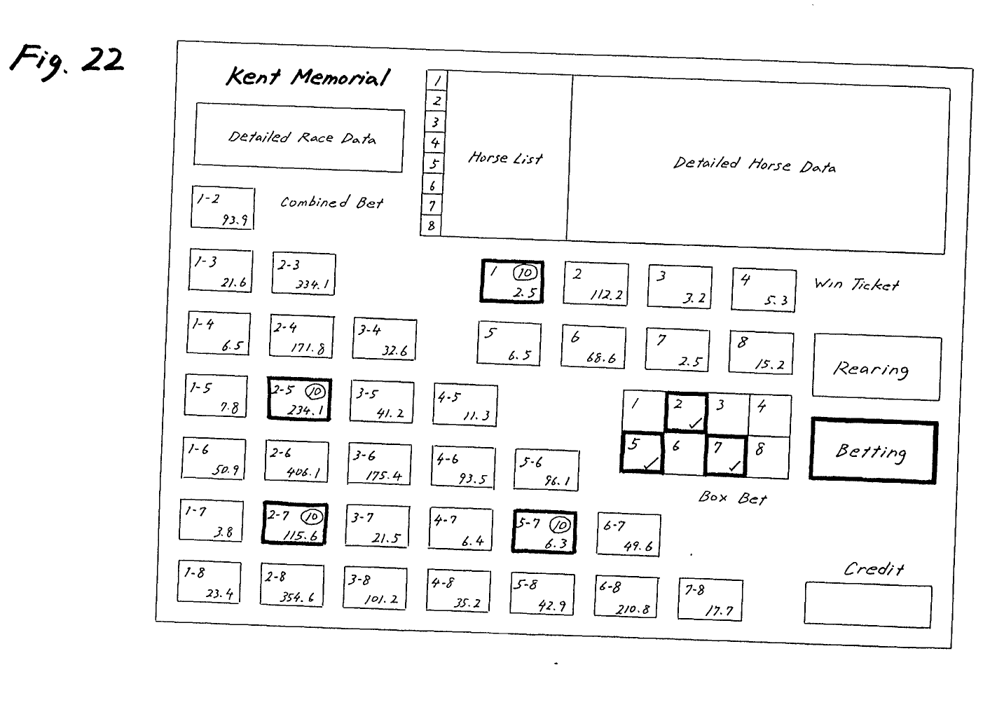

As mentioned above, processing for reserving establishment of “Kent Memorial” special race is effected during the ranking processing performed at the end of each month, a “Kent Memorial” special race occurs at a predetermined time, such as an n-th race from the beginning of the next month or at an arbitrary time, in the manner as shown in FIGS. 21 and 22.

The player's name is taken as the crown part of name of The “Kent Memorial” special race. However, establishment of the special race does not involve awarding game tokens to the player. Although it is not always the player has an absolute right to enter the special race, establishment of a special race, the crown part of whose name comes from the player, tickles the player's pride, thus rendering a game more attractive.

In the present embodiment, special race establishment processing is effected not in terms of a game calendar but on the basis of a sum of ranks actually computed at the end of a month. However, ranking processing may be effected in terms of a game calendar. Further, ranks may be summed every year. In addition to a special race for honoring a retirement horse, a special race may be held for a horse on an active list at a fifth race since the total amount of acquired prizes has reached 10000 tokens or after the horse has won a triple crown. In the present embodiment, the special race is taken as a G1 race. However, a G1 race is held for the first-rank honored horse shown in FIG. 19, and a G2 race may be held for the second-rank honored horse.

As mentioned above, in reality, a special race including the player's name as a crown part cannot be held as a result of a retirement operation performed by the player, achievement of the first rank, or achievement of a triple crown. Hence, game participants' attraction for games is incremented, and the sense of achievement in a game is also increased.

In the previously-described embodiment, the play status and history of a player are stored not in a magnetic card but in the game machine 1. Hence, when the game machines 1 are installed independently, the player cannot resume continuation of an interrupted game without use of the same game machine 1. Hence, the plurality of game machines 1 may be interconnected by way of any communication means, thus enabling transfer of player data. Transfer of player data enables the player to resume continuation of the interrupted game through use of another game machine 1.

The game status and history of a player may be stored in a portable recording medium, such as a magnetic card or an IC card. In this case, the player can resume continuation of a game through use of information stored in the portable recording medium. Hence, there is obviated a limitation on a game machine to be used for playing continuation of a game. Consequently, the player can enjoy continuation of a game in another location where a game machine is installed.

In the present embodiment, an ID code is changed every time a game is interrupted (step S314). However, changing an ID code is not necessary. Invalid use of a magnetic card can be prevented by changing of a check code. hence, a given ID code may be fixedly set for one magnetic card. Further, only an ID code may be employed as ID information.

Although the present embodiment has described a game for rearing racehorses as an example, the present invention can be applied to a game in which a player can entertain the course of tuning-up of a race car or the course of improving the capability of a professional cycle racer. The term “rearing” used herein is a concept including improvements in the capability of all objects appearing in a game or control of the capability.

What is claimed is:

1. A game machine, in which a plurality of racing members, each having a member name, participate in a plurality of races taken place therein, comprising:
a name assigner, which assigns a player name which is registered by a game player to an associated racing member as a part of the member name thereof; and
a special race establisher, which establishes a special race having a race name as one of the plural races, and assigns one player name to the special race as a part of the race name thereof, when a racing member to which the one player name is assigned has a race record better than race records of another racing members.

2. The game machine as set forth in claim 1, further comprising a race record evaluator which evaluates race records of the respective racing members in accordance with race results in a predetermined time period.

3. The game machine as set forth in claim 2, wherein:
the race record evaluator displays a ranking table in which the racing members are ranked in accordance with the race results; and
wherein the special race establisher determines the race name of the special race based on the name of a racing member first-ranked in the ranking table.

4. The game machine as set forth in claim 1, wherein:
the race is a horse races;
the racing members are miniature racehorses; and
the race record includes the number of prizes acquired by each miniature racehorse.

5. A method of running a racing game in which a plurality of racing members, each having a member name, participate in a plurality of races taken place therein, comprising the steps of:
assigning a player name which is registered by a game player to an associated racing member as a part of the member name thereof;
establishing a special race having a race name as one of the plural races; and
assigning one player name to the special race as a part of the race name thereof, when a racing member to which the one player name is assigned has a race record better than race records of another racing members.

6. The game running method as set forth in claim 5, wherein race records of the respective racing members are evaluated in accordance with race results in a predetermined time period.

7. The game running method as set forth in claim 6, wherein:
a ranking table in which the racing members are ranked in accordance with the race results is displayed; and
the race name of the special race based on the name of a racing member first-ranked in the ranking table.

8. The game running method as set forth in claim 5, wherein:
the race is a horse races;
the racing members are miniature racehorses; and
the race record includes the number of prizes acquired by each miniature racehorse.
